(19) United States
(12) Patent Application Publication
(10) Pub. No.: US 2002/0184104 A1
(43) Pub. Date: Dec. 5, 2002

(54) Integrated retail and wholesale system

(76) Inventor: James Littman, Cncinitas, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/872,417

(22) Filed: May 31, 2001

(51) Int. Cl. G06F 17/60

(52) U.S. Cl. 705/26

(57) ABSTRACT

The present invention relates to integrate the online and store shopping experience for a consumer of personal accessories such as jewelry and provide a system of the type described in which cost of selling is decreased in order that price to the customer for a given piece may be decreased and further provides a system of the type described in which a store can establish branding of otherwise fungible merchandise and to combine the integrated system with various marketing tools to provide the jewelry system operator, the jewelry store and the consumer cost benefits of just-in-time “manufacture.”

### FIELD OF INVENTION

The present invention relates to an integrated system in which retailers may supply users with accessories, e.g. jewelry in stock or from a fulfillment center and in which the fulfillment center coordinates needs of manufacturers, retailers and users.

### BACKGROUND OF THE INVENTION

While the present invention will have wide utility, it is particularly suitable to the jewelry market. In 1999, United States jewelry retail sales were $45 billion. They are projected to reach $61 billion by 2004. While the United States Department of Commerce predicts that overall e-commerce sales will reach $2.3 trillion by 2003, the jewelry industry continues to stall in making major e-commerce gains due to problems with product presentation, quality assurance and the lack of face-to-face interaction.

There have been attempts to utilize online interaction in the jewelry business. Some successes have come in business-to-business operations and in the example of QVC, an e-commerce business to consumer home shopping service. However, the QVC model requires extensive use of television broadcasting at great expense and neither method provides the touch and feel of the human interaction. A number of business to consumer websites have gone out of business. There are the usual problems of lack of interaction, consumers being wary of unknown sources, the process of buying over the internet does not distinguish one “e-tailer” from another.

It is highly desirable to provide a system in which the user can visit the jewelry store providing both physical and virtual in-store product lines, have an entertaining and unique cyber shopping experience using a virtual try-on console and reliable trouble-free fulfillment services. The jeweler is to leverage his physical inventory through use of the virtual inventory.

### SUMMARY OF THE INVENTION

It is therefore general object of the present invention to integrate the online and store shopping experience for a consumer of products such as jewelry.

It is a further object of the present invention to provide a system of the type described in which cost of selling is decreased in order that price to the customer for a given piece may be decreased.

It is a further object to provide a system of the type described in which a store can establish branding of otherwise fungible merchandise.

It is also an object of the present invention to combine the integrated system with various marketing tools.

It is a further specific object in one form to provide the jewelry system operator, the jewelry store and the consumer cost benefits of just-in-time “manufacture.”

Briefly stated, there is provided in the present invention a method for retailing personal accessories, e.g., jewelry in which a jewelry company integrates a shopper's online and in store shopping experience, creates individual branding for different jewelers each of whom participate in the system, markets on behalf of the jewelers and operates a fulfillment center which fulfills orders to shoppers and provides orders to jewelry manufacturers. The company integrates marketing, fulfillment and manufacturing.

A shopper interfaces with a kiosk in a jewelry store. The kiosk is an interactive retail center. The shopper may save an image taken at the kiosk and e-mail it. The kiosk features product information, a virtual “try-on” service in which a shopper may manipulate images of jewelry on images of a model or the shopper. The shopper may view actual and virtual inventory at the kiosk. The shopper views jewelry that is branded at the kiosk with the participating jeweler's name. The shopper may order from a limited actual inventory in the kiosk, order from virtual inventory, register preferences to be remembered by the system and may e-mail another person a picture with the jewelry being modeled. The purchase may be from stock or be sent to a fulfillment center for overnight deliver to the jeweler or shopper. The fulfillment center tracks orders and shipments and orders from suppliers as needed. A main server collects and analyses market data, provides e-mails, can provide marketing campaigns and control the other system as need be. The kiosk experience is also mirrored in a website, each jeweler having its own website and branding so that a shopper may from home simulate the kiosk experience, having developed confidence therein. However, at the present time most monitors cannot take a picture of the shopping at home for modeling of the jewelry. However, the image at a kiosk may be saved to a disk for the shopper or e-mailed.

### BRIEF DESCRIPTION OF THE DRAWINGS

The method by which the foregoing invention is achieved is pointed out with particularity in the claims forming the concluding portion of the specification. The invention, both as to its organization and manner of operation, may be further understood by reference to the following description taken in connection with the following drawings.

Of the drawings:

FIG. 1 is a diagram of a system performing the method of the present invention partially in block diagrammatic form and partially in perspective;

FIG. 2 is a block diagram illustrating further details of an interactive retail center illustrated in FIG. 1;

FIG. 3 is a block diagrammatic representation of the network architecture of a system performing the present invention;

FIGS. 4-8 are screens which may be presented at the interactive retail center or to a large degree on a web page; and

FIGS. 9-13 are flow charts illustrating operation of the present invention.

### DETAILED DESCRIPTION OF THE INVENTION

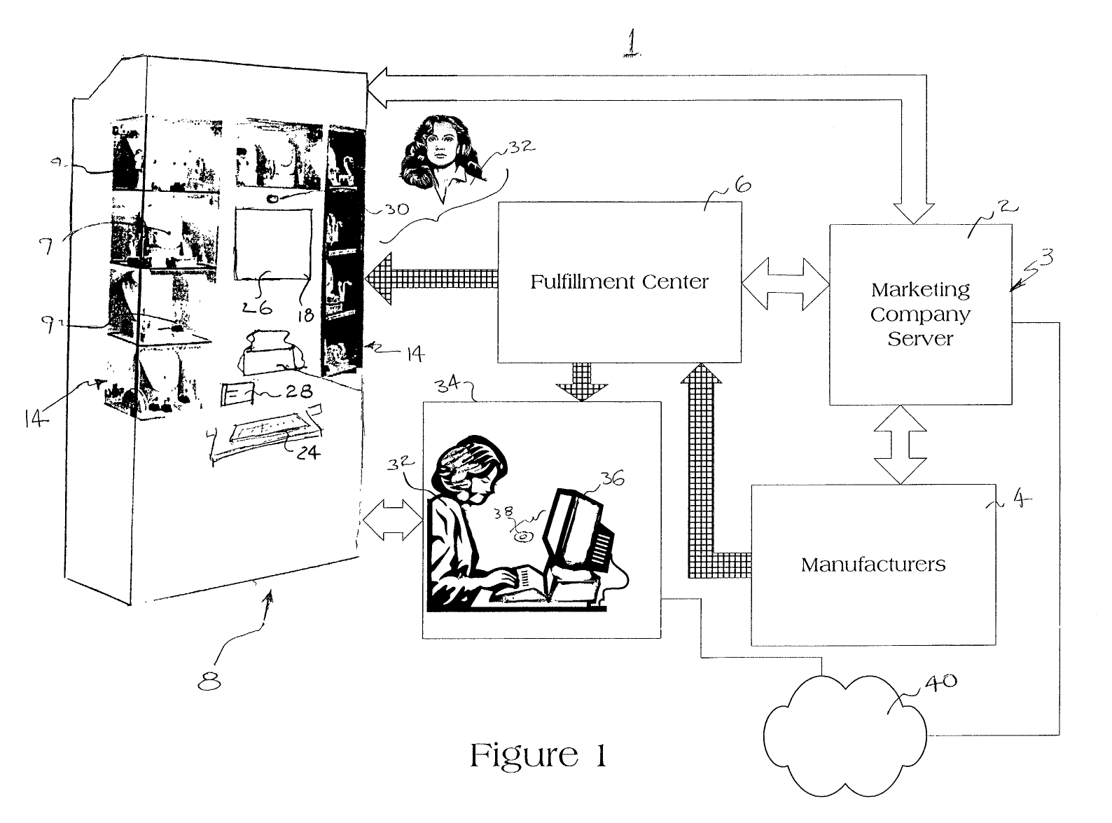

FIG. 1 is an illustration of a system according to the present invention for performing a method according to the present invention. The present invention is a marketing system and method. It is discussed in the context of jewelry marketing wherein the present invention provides a particular advantage. Use of the present invention provides a particular advantage. However, the invention may provide utility in other contexts. The present invention profiles a physical inventory that is available for sale and which also provides for a virtual inventory that may be much larger than the physical inventory. The physical inventory also gives a shopper an idea of the characteristics of the virtual inventory. Consequently the virtual inventory is not simply an unknown quantity to the shopper.

Since a retailer participating in the system and method may leverage the actual inventory by creating interest in the virtual inventory, working capital required to be extended by the retail jeweler is greatly reduced. Further, since the marketing company is working with a great many individual retailers and tracking sales and demand, it can cooperate with manufacturers to participate in “just-in-time” manufacturing. Inventory costs are greatly reduced. Further, since just-in-time manufacturing may be used and retailers do not have to carry as great an extended actual inventory. Therefore jewelry manufacturers have their working capital costs greatly reduced since they do not have to wait a long period of time for payment. In the jewelry market, it is customary for jewelry manufacturers to grant wholesalers 80 to 125 days to pay for delivered goods. Manufacturers have to bear significant financing costs. Further, until the time they actually received cash settlement, they are at risk of not being paid.

The present method and system also provide the opportunity for retail jewelers to brand their jewelry and create a product, image or quality level in the minds of their customers. With the exception of watches, most jewelry is not branded. Consumers who typically do not have product knowledge do not easily recognize heighten-quality jewelry products. The retailer can create loyalty to the jeweler brand. When the shopper uses the retailer's website, the credibility created by the in store retail center reinforces the shopper's confidence in the website. The present system and method also provides the opportunity for shopping and the context of a retail jewelry setting which is more attractive to shoppers than the simple online experience unreinforced by the retail jewelry shopping experience.

FIG. 1 is a block diagram representing the present method and system. The system 1 in the preferred form is operated by a marketing company 3 represented by a marketing company server 2. The server 2 will coordinate operations. The marketing company 3 maintains supply arrangements with a group of manufacturers 4. The marketing company 3 preferably has a contract with the manufacturers to manufacture the product only for the marketing company 3. The marketing company 3 also maintains a fulfillment center 6. The product, such as jewelry 9 is distributed via retailers 8. The box 8 in FIG. 1 is labeled “retailer(s)” since the box 8 represents both an individual retailer 8 as well as all retailers 8 each of whom may be a licensee, subscriber or have some other predefined arrangement with the marketing company.

The retailer 8 maintains an interactive retail center 10. The interactive retail center 10 may comprise an interactive terminal 12 and inventory cases 14 containing actual inventory such as jewelry 9. The interactive terminal 12 may, for example, comprise a monitor 18, processor 20 and user interfaces such as a keyboard 24 and touch screen 26. A graphic user interface 28 and video camera 30 may be provided too. The interactive retail center 10 is utilized by a shopper 32. Shopper 32 may also shop at home 34 from a home terminal 36 such as a home computer. As with retailers, shopper 32 here refers to one user, and may refer to all users as well and may comprise one or various individual persons or a plurality of persons. Often a shopper 32 may comprise a plurality of people such as two friends, spouses, or parent and child. A data flow arrow is indicated between the retailer 8 and the home 34 even though a shopper 32 will be communicating via internet 40 to the marketing company server 2. However, since the retailer 8 has a branded website, the shopper 32 will have the experience of communicating with the retailer 8. The retailer 8 benefits by not needing to develop its own website. A compact disk (CD) 38 may also be provided to the shopper 32 for offline use. A CD 38 may also be used at the interactive retail center 10 for continued operation even if networks on internet service providers become unavailable.

The marketing company 3 preferably has its own portfolio of jewelry designs that are manufactured for it by the manufacturers 4. Jewelry is ordered by the marketing company server 2 and shipped by the manufacturers 4 to the fulfillment center 6. Orders to the marketing company from the retailer 8 are processed with the marketing company server providing directions to the fulfillment center 6. Ordered products may be shipped directly to the retailer 8 or drop shipped to a home 34 by the fulfillment center 6 utilizing shipping material with the brand of particular retailer 8 that placed the order.

Retailers 8 can liquidate goods by supplies and products and attend e-education seminars in their stores as part of the network of retailers 8. The marketing company is able to collect invaluable customer data that can be used for inventory management, cross selling and upwelling. Manufacturers deliver products to the fulfillment center 6. There are sales contracts between the marketing company 3 and the manufacturers 4. Manufactures 4 do not deal with the retailers 8. Separate contracts are made between the marketing company 3 and the retailers 8.

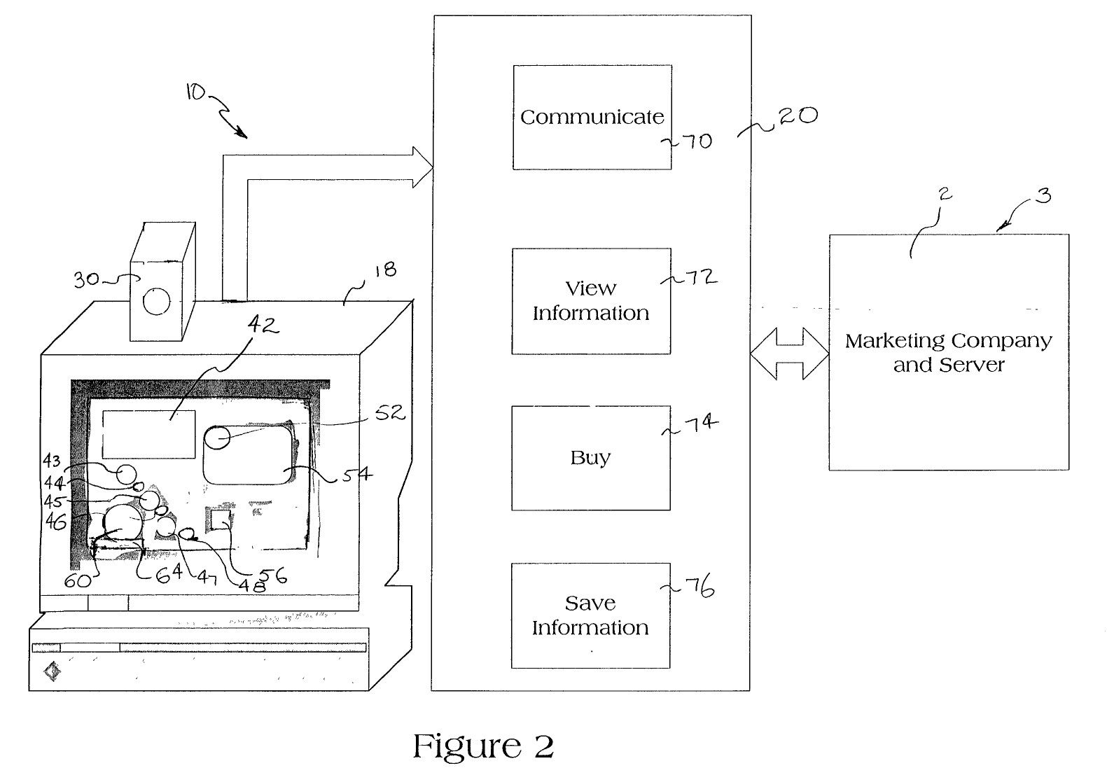

FIG. 2 is a partial illustration of the interactive retail center 10 and its interaction with the system 1. The terminal 18 is illustrated in a front view showing the touch screen 26. The touch screen 26 contains many fields for conveying information to a shopper 32 or receiving inputs from a shopper 32. A first field may comprise a branding field 40 will include a retailer's trade name, trademarks if desired, and a preferably toll-free customer service telephone number. Trademarks and other logos may also be included as desired, depending on the constraints of graphic design. A plurality of navigation buttons 43-48 are provided. A greater or lesser number of navigation buttons may be provided, and fewer than all the buttons provided may be utilized. It should also be noted that navigation buttons will lead to different screens, and different fractions may be associated with each button at a different screen. Buttons may be active or inactive on a selected screen.

A plurality of further display fields may be provided featuring particular products or collects and these displays may be changing or fixed. For example, a display field 52 may be provided featuring a particular group of items. The user 32 may touch the field 52 to lead to further information about a group of jewelry. A sub field 54 may be provided in the field 52 featuring the particular item from within the collection. The display within the fields 52 and 54 may vary so that a field 54 and 52 associated with the first collection appears for a first period of time, i.e., a predetermined number of seconds, and information for other collections is displayed in subsequent time periods. A fixed display 56 may also be provided.

In a field 60, audio-visual information is provided. The field 60 may display an image of a narrator. Audio-visual narration data is stored, and audio-visual scripts associated with the current state of the interactive retail center10 are displayed. The current state is characterized by the last command provided by the computer 12. This may correspond to the last information field touched, the last information entered, the initialization of the system or an initial introduction whose initiation is triggered by a sensor sensing the presence of a shopper 32 near the interactive retail center 10.

Field 64 contains, for example, the usual plurality of selectable fields, which in the present example will describe the retailer. The use of common fields are commonly known as about us, contact us, site map, privacy statement, terms & conditions and FAQ (frequently asked questions). This information is commonly maintained at the marketing company server 2, providing the marketing company control and maintaining uniform terms and conditions and control of the privacy statement needed both for legal compliance and to give the customer full notice of the nature of the system so that the marketing company may ethically perform permission based marketing in furtherance of the method of the present invention. The jeweler benefits from being able to engage in its business of retailing rather than in site development.

The shopper 32 may view information by simply watching changing displays on the touch screen 26. Shopper 32 may also press button 43, which in the present embodiment is labeled “go shopping.” Which will lead to further screens each providing further levels of detail. Such further levels of detail may include a search function, selection of particular pieces of jewelry accessed by the search, and at another level further information about a particular piece of jewelry. The shopper 32 may also use a virtual try on capability using a touch button to access a screen with a selected image of a model. Alternatively, the video camera 30 may take a picture of the shopper 32 and impose an image of a piece of jewelry on the shopper 32. An additional camera 31 inside the interactive retail center 10 takes an image of the hand of the shopper 32 when that option is selected. Well-known video controls are used to move and orient and re-size the jewelry image in proportion to the image on which the jewelry is superimposed. The creation of an image with the jewelry superimposed on the image of a wearer is an opportunity for the shopper 32 to communicate. An e-mail may be created with the image of the wearer and the jewelry being sent as an “e-postcard.” Processor 20 may store pre-written messages for selection by a user 32 and may also provide the opportunity for the user 32 to create a new message or add to a pre-loaded message utilizing the keyboard 24.

Once the shopper 28 has established an identity in the system, the shopper 32 may perform the operation 76 of saving information. Such information can include a wish list. It may also include a record of items the shopper has bought and a calendar for reminders regarding persons and occasions for which jewelry gifts may be appropriate. The marketing company 3 may also utilize information input by user 32 into a registry function to remind the shopper of such occasions.

The shopper 32 may engage in a buy operation 74. The system may use conventional e-commerce software. However, in accordance with the present invention the shopper 32 has an experience differing from prior art e-commerce solutions. First, the shopper 32 could make a selection from the jewelry cases 14. Secondly, the shopper 32, if ordering an item in virtual inventory may return to the retailer 8 to pick it up. Fulfillment center 6 is normally geared to provide next day delivery to the retailer 8. Alternatively, as illustrated in FIG. 1, the jewelry may be shipped to a home 34.

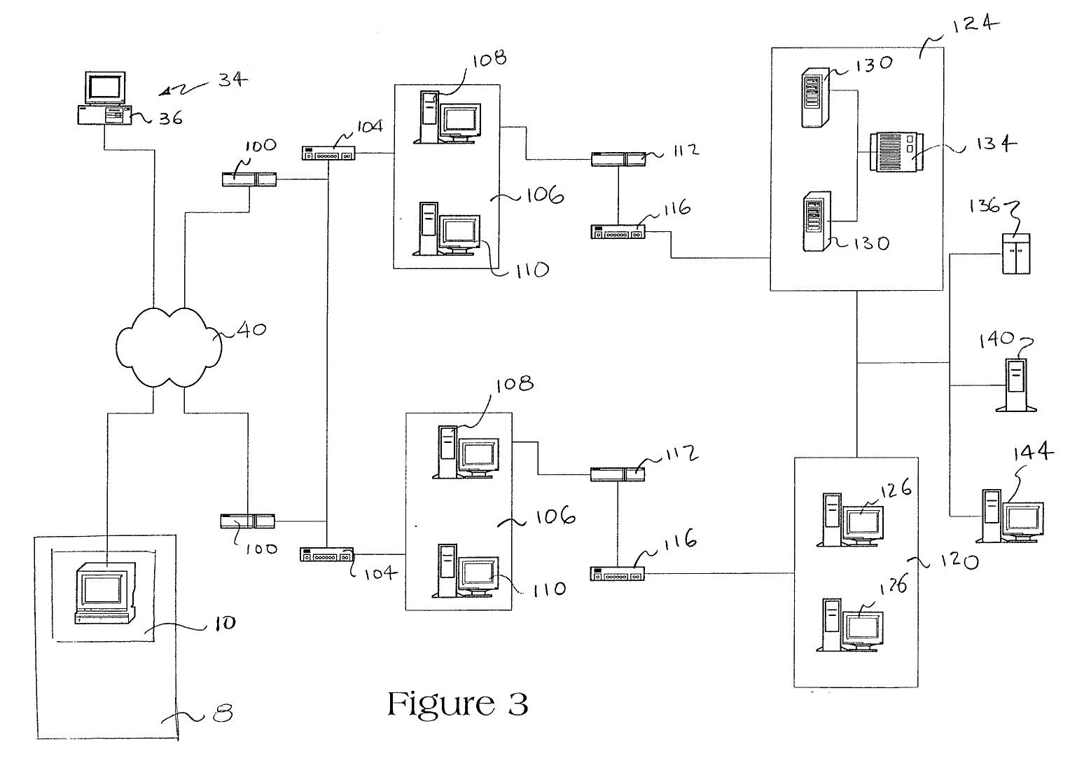

FIG. 3 is a block diagrammatic illustration of the system of the present invention. Again, in FIG. 3 the same reference numerals are used to denote the same elements that they denote in FIGS. 1 and 2. In FIG. 3, two retailers 8 are illustrated interfacing via the internet 40 to the marketing company server 2 with a number of dots placed therebetween. The dots indicate that a plurality of retailers 8 is interfacing with the marketing company server 2. The system can support anywhere from a few retailers 8 up to thousands of retailers 8. Indeed if the market were large enough, the marketing company server 2 could support more than thousands of retailers 8. In FIG. 3, the marketing company server 2 is illustrated as having first and second router/firewalls 100 interfacing with the internet 40. The actual number may very widely and in accordance with well-know network concerns. Two routers 100 are illustrated to demonstrate a system that will remain up even in the fact of network problems or denial of service attacks. Routers 8 are coupled to the routers 100 are coupled to hubs 104 providing inputs to groups of servers 106.

Each group of servers 106 may conveniently comprise 4 to 32 servers. In the architecture of the specific example of FIG. 3, the servers 106 include an architecture comprising a Windows load balancing service cluster (WLBS) 108 servicing the 4-32 servers. For further security, the site servers 106 are each connected via a firewall 112 and hub 116 to a secure fulfillment server 120 and a data server 124. The secure fulfillment server 120 comprises a WLBS cluster 126. The data server 124 comprises structured queried language (SQL) servers 130 communicating with a shared disk array 134. The marketing company server 2 further comprises in analysis report server 136 for receiving and analyzing marketing information, an e-mail server 140 for handling e-mails to and from shoppers 28 as well as e-mails to and from the retailer 8 or manufacturers 4. Additionally, a staging server 144 is provided. Of course many equivalent arrangements may be provided. The particular exemplification of FIG. 3 is selected since it is an expandable design and represents a desired arrangement for a growing marketing company 3.

There are two sets of firewalls. The first set, the firewalls/routers 100 allow access of individual servers within the marketing company server 2 to be accessed by inquiries redirected from authorized internet service providers (ISPs) only. The second set of firewalls 112 separates the web application servers 106 and 108 from the rest of the servers within the marketing company server 2 as a further safeguard to protect customer information and financial utilities from public access. Access via a kiosk 8 or home computer 36 is generally by HTTP (hypertext transfer protocol), and HTTPS secured HTTP, for secured services such as providing customer information and commercial transactions. Systems software in the servers 106 supports the branded internet websites and the interactive retail centers 10. A round robin domain name system (DNS) provides load-balanced, highly available internet connectivity. A site name, the www address of a retailer, alternately points to two IP addresses within a server 106. Preferably, the URLs if retailers 8 will also include a name associated with the marketing company 3's method. An example is of the form www.jewelername.emotionsgallery.com. Emotions Gallery is a trademark of the assignee herein. As a result, user sessions are established by the two routers 104 to be load-balanced.

Within each server 106, the windows load-balancing system 108 provides a scalable platform for two load-balanced highly available web server clusters 110 each running Microsoft brand IIS. HTML files, ASP (active server page) files and graphics files are all kept on the clustered servers 110. An example of a highly suitable scheme for providing infrastructure for personalization and membership services for each retailer 8, search services, content replication among web servers and cross-selling services is Microsoft Site Server. The servers 108 provide a platform for Site Server, P&M services and a database for the Site Server P&M application. The payment service is included. A payment gateway serves secured credit card payment via SSL.

The marketing company server 2 supports the virtual try on function at the interactive retail center 10 through the ASP files maintained in the servers 110. The servers 110 also contain main retail system pages and system administration pages. An administrator may perform tasks like uploading product images and defining system settings. Retail pages included in the ASP files provide functions of the retail system. An image overlay module is open via a retail page to run on the processor 20 of the interactive retail center 10. This module interacts with stored visions of models or with web cameras 30 and 31 that may respectively produce images of a frontal view of the shopper 32 or the hand of a shopper 32. Optimal caching of image files is implemented. In a further preferred form, an optional replication module is available for inclusion in processors 20 to pull appropriate image files from the servers 110 and update cached graphics in a browser and in the image overlay module.

Preferably, retailers 8 have retailer-specific domains registered. Shoppers 32 then use retailer specific URLs to go to relevant content. The virtual shop ASP file pages miniservers 108 redirect URLs to correct content. Registration of individual shoppers 32 are associated with particular retailers. Each retailer may have its own user base. When shopping, a shopper 32's payments would be processed by SSL transported forms which connect the users to the fulfillment server 120. Shoppers 32 are provided with security over the entire communication path they use.

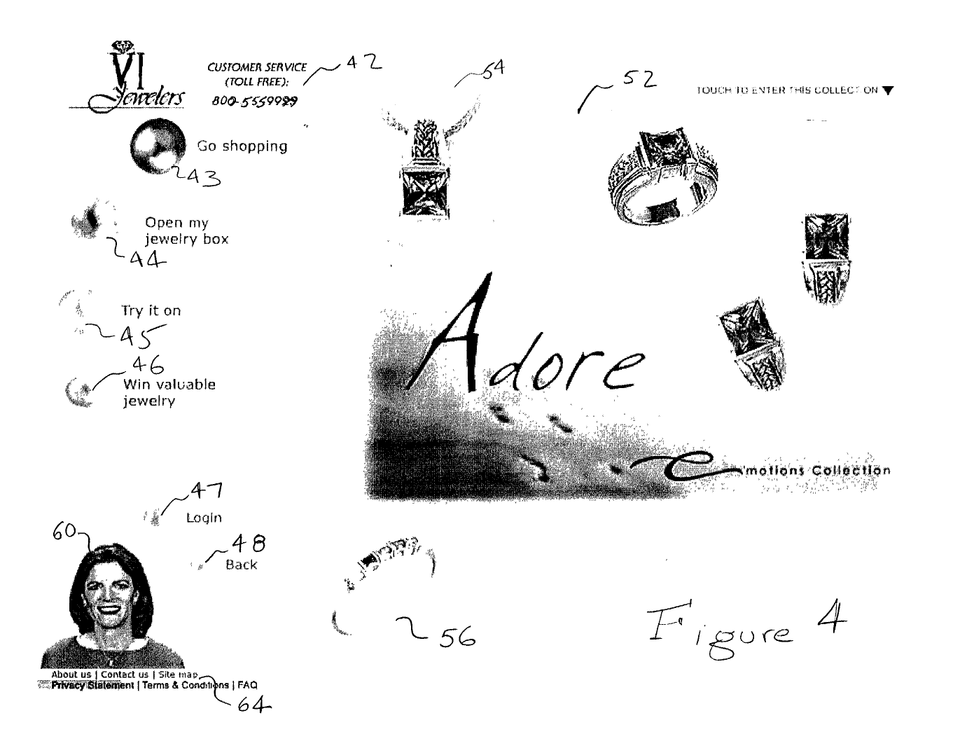

The SQL servers 130 are used for “backend” database platform purposes and may be scaled to support, for example, a million customers. SQL server DTS, Data Transformation Services, are used for importing existing product data into the system. FIG. 4 is an illustration of a nominal home screen for display at the interactive retail center 10 or on a home computer 36. Within the constraints of present technology, the home computer 36 will not have a touch screen. The same reference numerals are used for screen elements as in FIG. 2. Examples of the items discussed in FIG. 2 are illustrated. The user may navigate with a “go shopping” button 43 or may select to view further information with respect to variable fields 52 or 54 or with respect to the sixth field 56. These options are available to a casual viewer or to shopper 32 who has decided to have a personal profile created and maintained at the marketing company server 2. To create a personal profile, a shopper 32 may depress the button 47 which is a “login” button. The all-known functions may perform the login function.

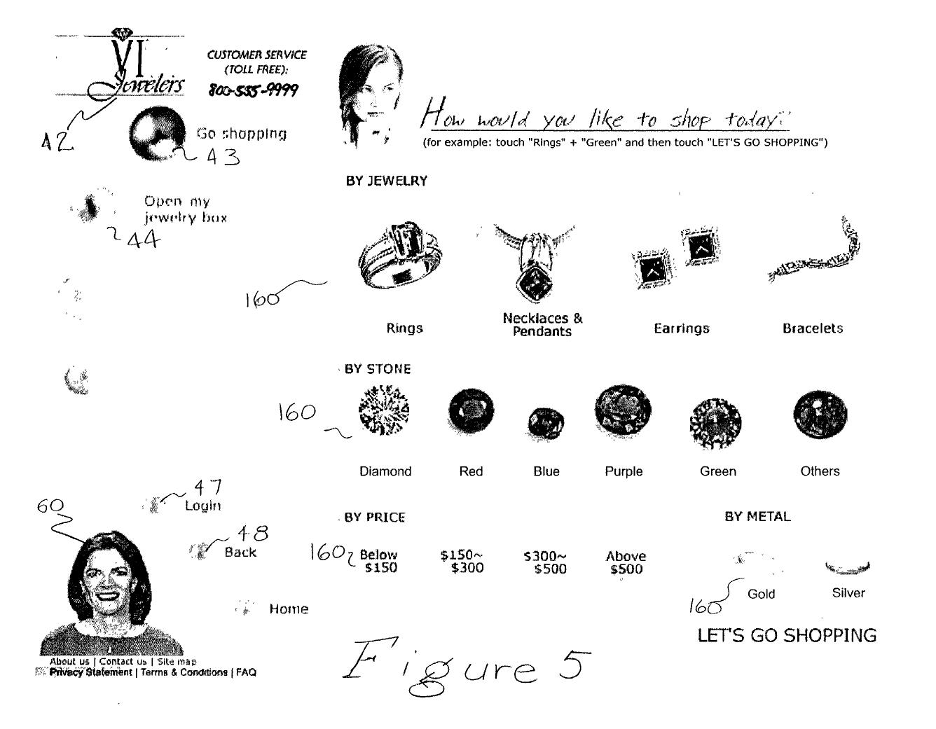

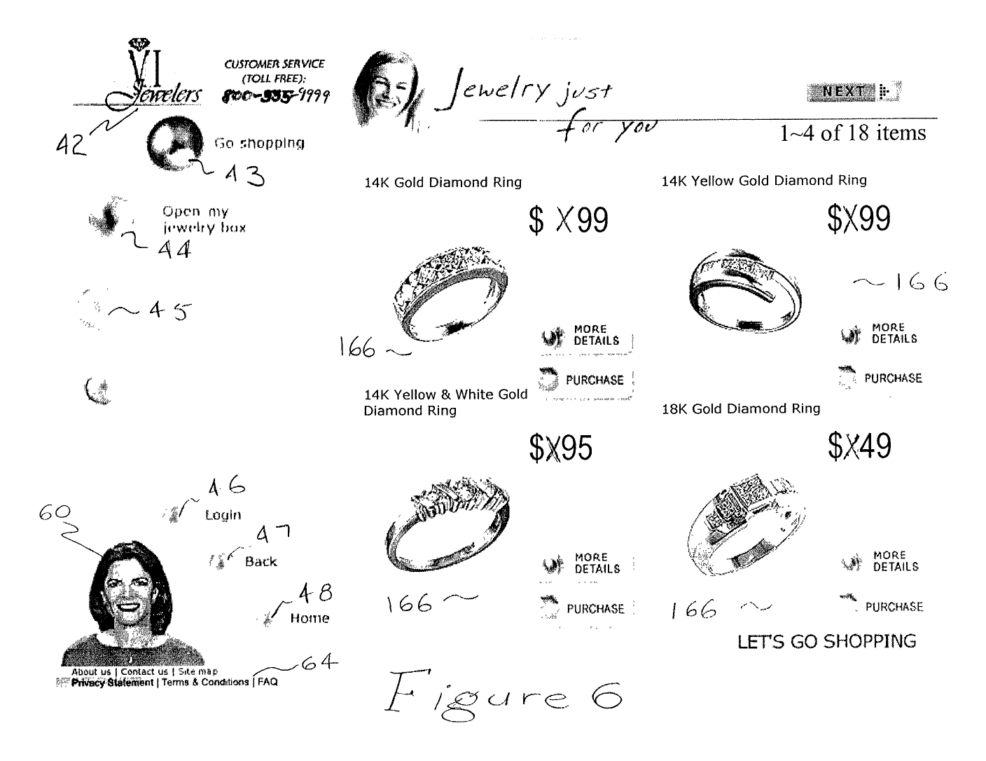

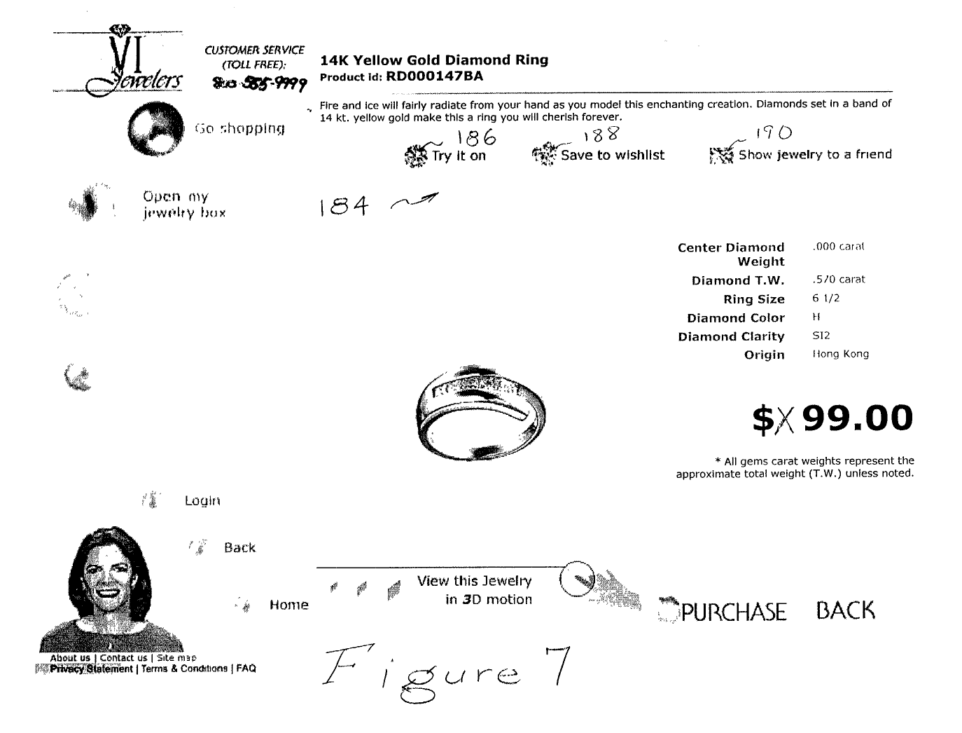

FIG. 5 is an illustration of a search screen accessed via the go shopping button 43. A number of fields 160 are provided. Selection fields may include jewelry type, stones, and price ranges as well as type of metal in a setting. The software in the server 110 may be said to force a shopper 32 to select values with a particular field or may allow an open search. FIG. 6 accesses initial jewelry information provided, which can be reached either through search criteria or by access of product fields 52, 54 or 56 of the screen of FIG. 4. One or more information fields 166 are provided providing an illustration of a piece of jewelry and option buttons such as “more details” button 168 and purchase button 170. The information fields 166 may also include price data. Selection of purchase button 170 whether by touch screen button on the touch screen 26 at the interactive retail center 10, or by pointing and clicking on a home computer 36, will lead to a secure purchase transactions which may be performed in a well-known manner through the hardware system of FIG. 3. Selecting the more details button 168 will lead to the screen of FIG. 7, at which further details are provided.

As seen in FIG. 7, a text field 180 describes specifications of the piece of jewelry. A further option field 184 is provided including buttons 186, 188 and 190 which are respectfully used to select virtual try on, saving to a wish list or showing to another. Selection of the button 186 provides for options of using store picture of a model from a server 110 or a new picture taken by camera 30 and/or 31 of the user 32 on which a jewelry image is superimposed. Through button 186, information on the jewelry may be saved to a wish list and the shopper 32's profile. Alternatively, the user 32 may show a piece of jewelry to a friend by selecting “show to a friend” through button 190. An e-mail is created at a further screen in a known manner in accordance with the present invention, the e-mail does simply include text and a picture but also has image overly projection.

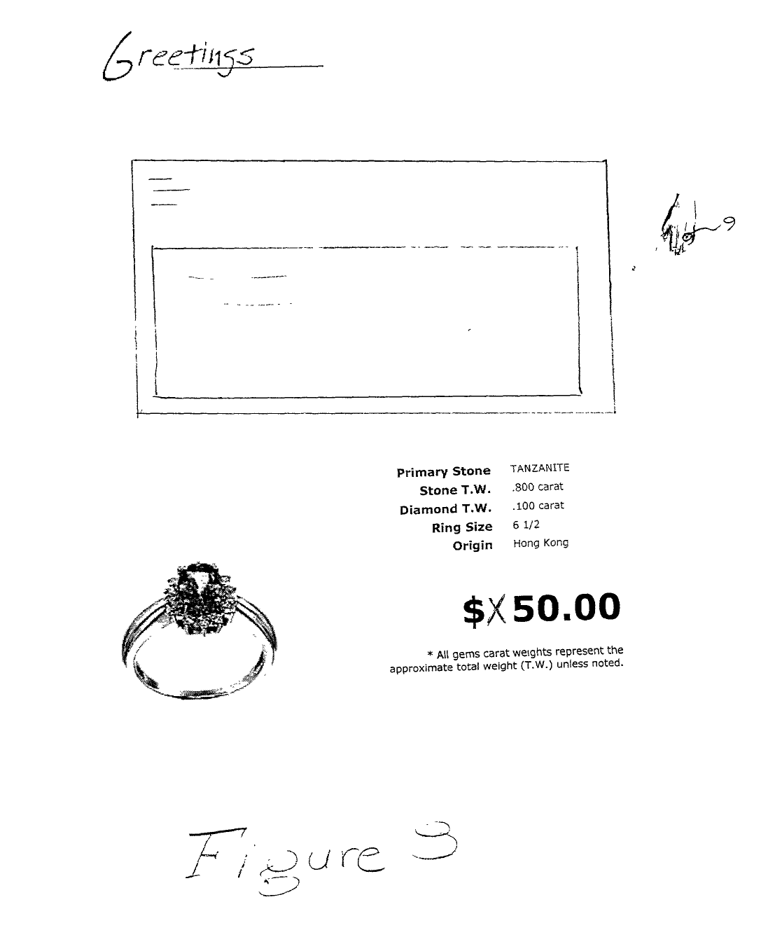

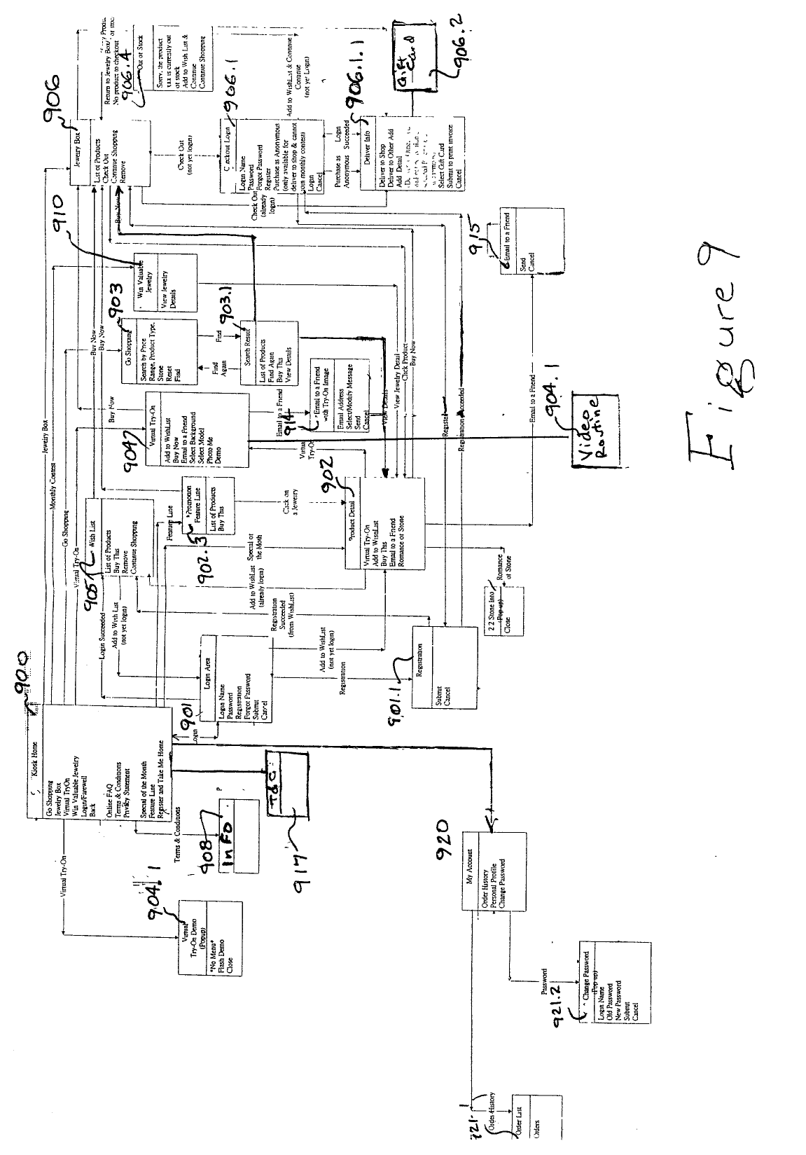

FIG. 8 is an illustration of an e-mail produced in response to utilization of the “sent to a friend” facility 200. FIGS. 9, 10, 11, 12 and 13 are each block diagrams of the method of the present invention illustrating performance of the method in terms of screens for shoppers 32, screens for retailers 8, screens for the fulfillment center 6, screens for content management and screens for system administration. The method at FIG. 9 begins and block 900 which is called kiosk home. Kiosk is a term which may be used for short description of an interactive retail center 10, but is less descriptive and specific. A shopper 32 may enter the home state many times. In the home state, the screen of FIG. 4 is presented. A user may proceed to block 901, login area. If a user has not registered, the user is directed to block 901.1, registration other routine login and registration functions are provided. A successful login may, for example, lead back to kiosk home. A product detail block 902 is provided for giving the shopper 32 information on products. The product detail block 902 may be reached from the home state 900 as by selecting buttons 52, 54 or 56 (FIG. 4) associated with featured products. Alternatively, a user may proceed from kiosk home 900 to “go shopping” block 903 as by selecting the button 43 (FIG. 4) to invoke the search function in block 903, the user may invoke the search capability described with respect to FIG. 5. This leads to block 903.1, search results. The shopper 32 may return to block 903 to find further information. Block 903.1, a user may choose to view details, which will again lead to block 902, product detail. Alternatively, the user may proceed from block 903.1 to jewelry box block 906. The jewelry box 906 maintains a well-know shopping cart function. From block 903.1 the user may also select to view details and be taken to block 902. Block 902 may be also reached from block 902.3 which may be reached from the home block 900 by selecting a promotion feature line. The marketing company 3 may also include a contest promotion so that at block 900, a user may select a “win valuable jewelry” button and be taken to block 910 where jewelry is illustrated. The user 32 may select “to view jewelry details” and also be taken to block 902.

From block 902, a user may opt for virtual try on and be taken to block 904. By selecting a virtual try on, the user is taken to a video routine block 904.1 at which video routine options are provided. The user may select a hand model for rings, an upper body view for modeling necklaces and earrings or such other model images as may be provided. The user, following prompts, may select another plurality of each type of model and may also elect to operate the cameras 30 and 31 (FIGS. 1 and 2) to get a video image so that the jewelry being virtually examined may be modeled right on the shopper 32. Another option available at block 904 is to add a piece of jewelry to a wish list, maintained at block 904. A wish list is a file associated with a user 32 and stored at the marketing company server 2 grid at block 905, if a shopper 32 is not yet logged in or registered, the shopper is directed back to block 901 and returned to block 905 after a successful login and/or registration. The shopper 32 may then elect a back function to be returned to the previous block, here block 904. Alternatively, the shopper 32 may elect “buy this” at block 905 and either be directed to the jewelry box block 906 or be required to login or both register and login. The user may also elect from block 902 to send an e-mail illustrating either the jewelry or both the jewelry and an image of the jewelry being modeled and is directed to block 915. At block 915, the shopper 32 is presented with visual selection to be provided in the e-mail such as backgrounds and may provide custom text such as by entry through the keyboard 26 (FIG. 1), prewritten messages provided from a menu or both. The e-mail capability is also reachable from block 902. The message from block 902 need not proceed through the selections in block 914 since product information rather than customized information may be provided.

The product detail of block 902 also provides access to a block 902.2 which provides particular information. For example, block 902.2 might present to the shopper 32 a rotating three-dimensional image of the jewelry.

Having made selections for purchase, the shopper 32 may prompt a check-out procedure. Where a selected item is out-of-stock, operations proceeds to blocks 906.4, out-of-stock. The shopper 32 is given the option to proceed to block 905 and add the item to the wish list and continue or simply to return to the go shopping block 903. This information is provided when the shopper 32 seeks to place an item in the jewelry box 906.

At block 906.1, the system detects whether the shopper 32 is logged in and may return the shopper to login are 901 for login or for login and registration as appropriate and return to block 906.1. The purchaser, the shopper 32 may register as anonymous and return to the retailer to pick-up the merchandise when it is available. Otherwise, operation proceeds to block 906.1.1 where delivery information is registered. A shopper 32 may proceed from block 906.1.1 to block 906.2 in order to select and compose a gift card and return to block 906.1.1. Once a finalized order is submitted operation proceeds to block 906.1.1.1, where a confirmation number and thank you message are generated. Customer information from operations following block 906 are stored in the marketing company server 2 during a separate marketing operation, user marketing information may be mined in accordance with new or known algorithms.

Other facilities may be provided. The user 32 may proceed from the kiosk home block 900 to block 904.1 to provide a demonstration of the virtual try on application. Also, facilities 908 may be provided for usual information such as that described at field 54 with respect to FIG. 4 such as frequently asked questions, privacy statement and information about the retailer 8. Additionally, a program option may be provided at home block 900 leading to a program block 918. The program block may be used for promotions or further general information to be provided by the marketing company 2. The program block may include educational programs for educating the shopper 32 and getting the shopper more involved in the shopping process. Also, from an account block option at block 900, the user can access block 920, entitled “my account.” Here, the shopper 32 must enter a password to find such things as the shopper's order history, personal profile and other desirable features, for example, login history. The shopper may access block 921.1 to find prior order lists and may proceed from block 920 to block 921.2 in order to update personal profile features. Similar functions may be provided to those at FIG. 9 to a shopper 32 connecting from home 34.

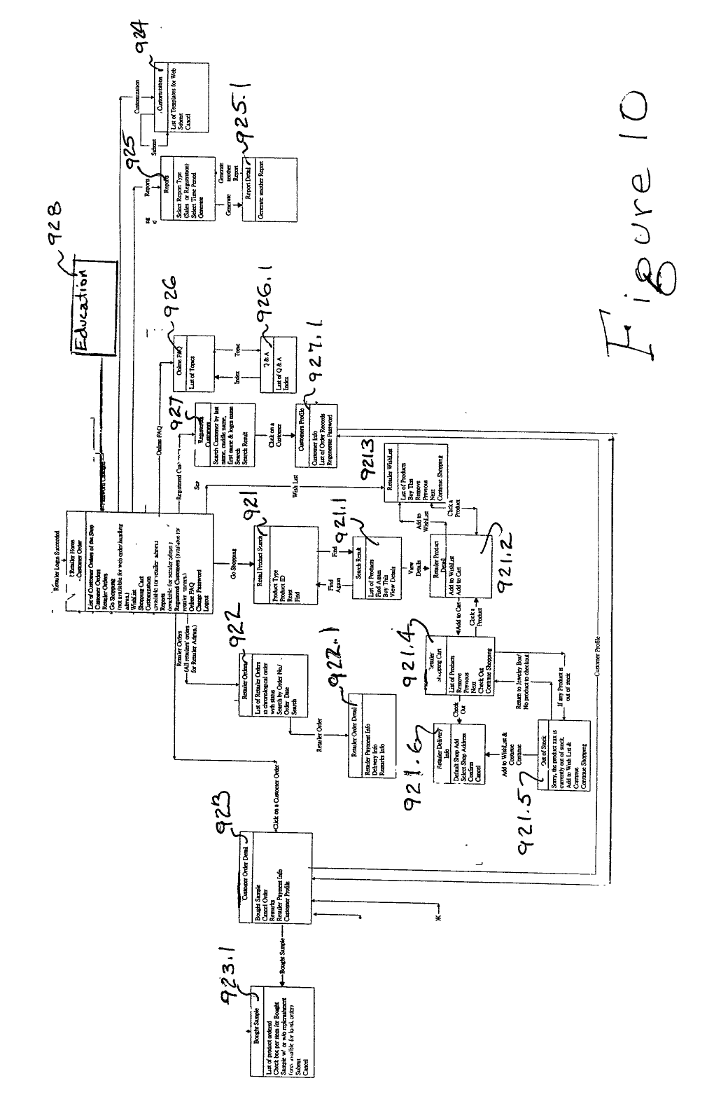

FIG. 10 is a flow diagram illustrating the retailer 8's interaction in the system according to the present invention. Retailers may begin at a retailer home page 922, which also illustrates a retailer terminal 922. The retailer 8 may go through a conventional logon procedure using user name and password to reach the home block 922. The retailer may manage customer orders and view current status. The retailer 8 may proceed to block 921 to shop for actual inventory or to learn more about the products in the virtual inventory at block 921. At block 921, the retailer 8 has the option to do a product search to obtain product results at block 921.1. The search leads to block 921.2, wherein retailers use product detail. The retailer may also add product to a retailer which lists at block 923. Alternatively, the retailer 8 may at block 921 point to select merchandise to put in an e-commerce shopping cart at block 924. The marketing company server 2 will interact with the retailer's shopping cart facility to provide at block 924.2 an out-of-stock notice. The retailer may add the item to the wish list at block 923. Similarly, a retailer could select from an existing wish list at block 923 and at products by operations at block 921.2 to the shopping cart at block 924. At block 921.4, the retailer 8 may initiate the check-out procedure and have the order processed at block 921.5. From operating at block 925, data is sent from the retailer 8 to the marketing company server 2 as illustrated in FIG. 1.

The retailer 8 may review its orders starting from block 920 by proceeding to retail order block 922 which is preferably arranged to provide a list of retail orders in chronological order with status of each. The retailer 8 may also use a search facility from block 922 to proceed to block 922.1 to find specific queried information. Again, this information is transmitted from the server 2 as illustrated in FIG. 1. From the home block 920, the retailer 8 may also proceed to analyze customer order details at block 923. The retailer 8 may proceed from block 923 to block 923.1 to administer orders from actual inventory in the jewelry cases 14 of the interactive retail center 10 (FIG. 1). The retailer 8 may also decide whether or not to replenish the item to the jewelry shelves 14.

From retailer home block 920, the retailer may proceed to block 924 for customization of its web site and screen 26 of the interactive retail center 10 within a range of possibilities provided by the marketing company 3. The retailer preferably selects from a list a templates and may customize the web site and the screen 26 accordingly. From home block 920 the retailer may proceed to report facility 925 and may elect to produce reports by types provided for on a menu. A selection is made at block 925.1. A report detail is generated and provided to the retailer 8 such as a sales report, registration report or other such report. The retailer 8 may select time periods provided in the report. Once again, the report generation process at block 925.1 may interface with the marketing company server 2 as illustrated in FIG. 1.

Again starting from block 920, the retailer may proceed to block 926 to review standard information provided to the marketing company server 2 such as frequently asked questions which may be accessed at block 926.1, terms and conditions between the retailers 8 and the marketing company 3 or other information. The retailer 8 may also proceed from block 920 to 927 to view information about registered customers and may further proceed to block 927.1 to find information about a particular customer. The retailer 8 may further query block 923 to get information about orders from a particular customer. Also, from block 920, the retailer 8 may proceed to education block 928, where the marketing company 3 may provide access to standing and or a period or periodic education programs, information or other marketing and education information for the retailer 8.

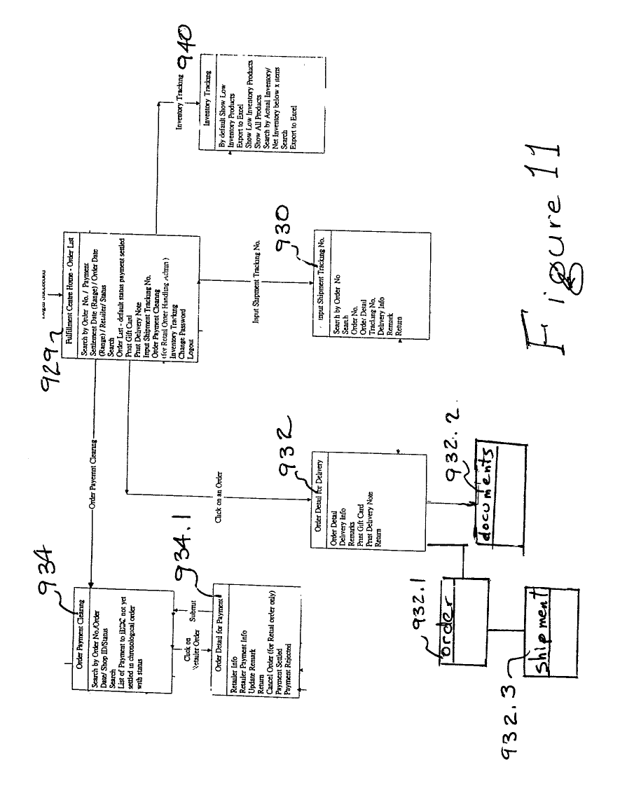

FIG. 11 is a block diagrammatic representation of the method and system with respect to operations initiated from the fulfillment center 6. Operation begins at a fulfillment center home block 929, which also illustrates a fulfillment center server 929. The home block 929 provides options for the functions including search by order number/payment, settlement date/order date, retailer/status and searches. An operator at the fulfillment center 6 or remote therefrom may request that the system proceed to block 930 to track shipments. At block 930, a search may proceed, order numbers may be directly input and tracking numbers may be sought so that the fulfillment center will know the status of a particular shipment.

Beginning from the home block 929 the fulfillment center 6 may proceed to block 932, order detail for delivery in order to initiate fulfillment of an order. The block 932 may provide commands to block 932.1 order picking to provide directions to a human or robot order picker, the block 932 may also initiate progress to block 932.2 documents. Here, shipping documentation, mailing labels and enclosures may be generated or manually picked from a stock. Here, additional advertising may be inserted in a package. Alternatively, instructions, complimentary accessories, such as a polishing cloth, or other items may be included in accordance with the scheme established by the marketing company 3. The order proceeds from block 932.1 to block 932.3 shipment. Here, confirmation is made to block 932 that an order has been shipped upon input of the correct information indicating shipment.

From the fulfillment center home block 929, a branch to order payment clearing block 934 may be selected. Options at payment clearing block 934 include searching by order number, identity of a particular retailer 8 or list of payments to the marketing company 3 not yet settled. A branch to block 934.1, order payment detail may be selected whereupon statuses are provided. The fulfillment center 6 may at block 934.1 generate cancellation of order to a retailer 8 should the retailer 8 be delinquent to the marketing company 3. Cancellation of an order to a shopper 32 would be a rare occurrence since settlement is normally made at the time of the shopper's selection. A credit card is generally used for web purchases and credit card and cash are often used at the retailer 8. The retailer 8 and the marketing company 3 will normally understand that the retailer 8 is at risk for payment by check since the retailer is normally in this position anyway.

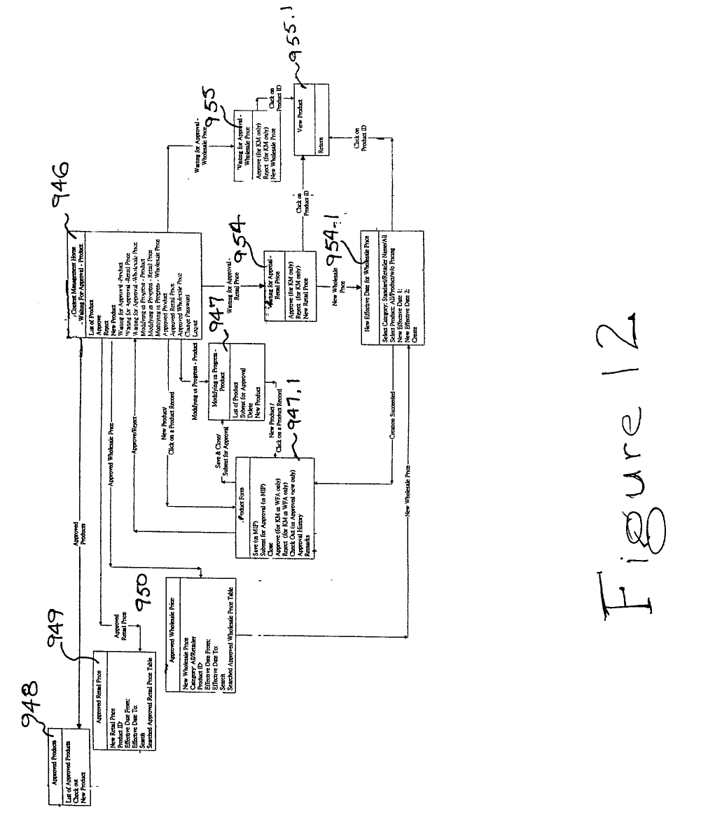

From the home block 929, the fulfillment center 6 may proceed to inventory tracking block 940. The inventory tracking utility performed at block 940 searches and shows low inventory products as well as all products. As illustrated in FIG. 1, the block 940 communicates through the fulfillment center 6 to the marketing company 3 so that the marketing company 3 may issue orders to manufacturers 6 for items that are low in stock. FIG. 12 is an illustration of the system and method relating to provision and management of content by the marketing company 3. Operation begins at a content home block 946. From block 946 operation at block 948 approved products may be elected. Here, a list of approved products for inclusion in the system of the present invention is maintained and new product information may be entered. The content manager may proceed from block 946 to block 949, approved retail price, which is a manufacturer's suggested retail price. Alternatively, the content manager may proceed to block 947 in which modifications to product information may be made. Block 947 may further have the option to communicate to an approval facility 947.1 so that modifications are only finalized upon approval of an authorized manager. Proceeding from home block 946 to block 950 the content manager can set in the system wholesale prices for the retailers 8. If there is a business requirement and a legal justification for different wholesale prices to retailers who may have a different cost of business associated with them, this to may be accommodated at the block 950. The data at blocks 948, 949 and 950 are stored in the marketing company server 2 as well as further data discussed below.

The content manager may also proceed from block 946 to block 954 or block 955 which respectively correspond to setting manufacturer's suggested retail price and actual wholesale price. At blocks 954.1 and 955.1, approval process and effective dates are communicated. Retail and wholesale price information is communicated to blocks 949 and 950 respectively. This is an internal transaction within the marketing company server 2. In the pricing process from blocks 954 or 955, a request to view the product and associated information therewith which may retrieve data from block 948, for example.

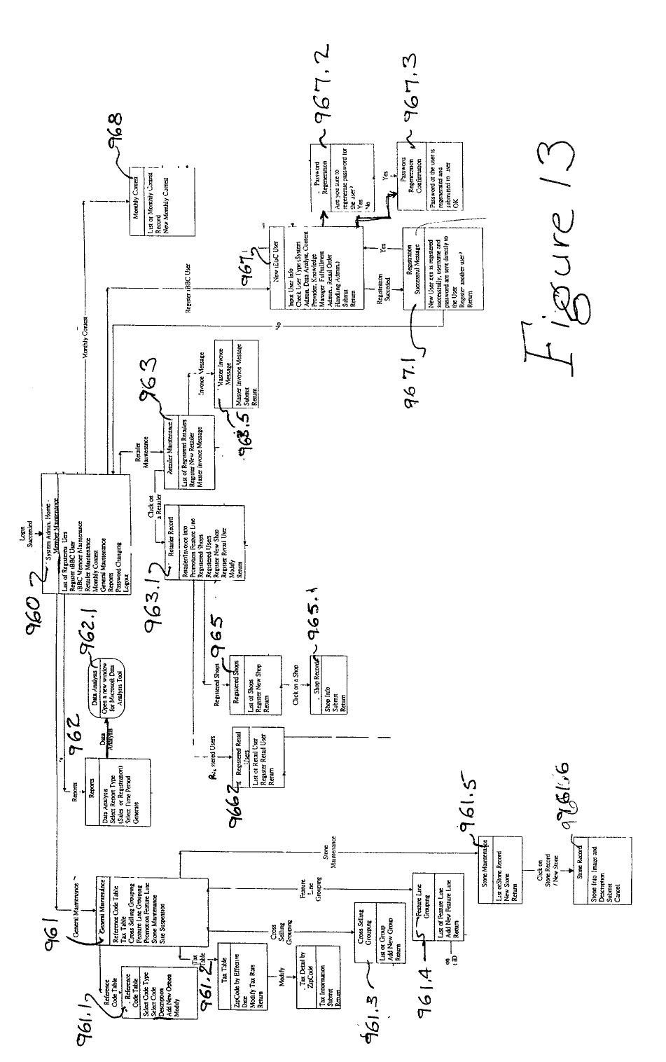

FIG. 13 is an illustration of the method and system for system administration at the marketing company server 2. At home block 965, the system administrator has access to a list of registered users, registration for new users, member maintenance, promotions such as monthly contests, general maintenance, reports and educational and other interactive content for retailers 8 and shoppers 32. From block 960 the administrator may proceed to block 961, general maintenance. In the present exemplification, general maintenance refers to a particular set of commercial data. In the present exemplification, the administrator may maintain tax code information at a block 961.1. At block 961.2, the system administrator may maintain tax tables. One way of maintaining tax tables is by zip code. Taxes vary by state and within a state, may vary by city, county or various forms of districts. At block 961.3, cross-selling grouping information is provided. For example, buyers of certain sorts of jewelry might be made offers on cologne. Cross selling algorithms are maintainable at block 961.3. At block 961.4, feature line grouping is maintained. Feature line grouping may, for example, include groups of jewelry to be displayed within collection fields 52 on the touch screen 28 (FIG. 4). At block 961.5, stone maintenance is maintained. Stones may be characterized by size, condition and other common characteristics. An operator may proceed from block 961.5 to block 961.5.1 to view stone images and information.

A systems administrator may proceed from home block 960 to block 962, reports. Various reports may be selected. Operation may also proceed to block 962.1 in which any of a variety of data analysis tools may be applied to selected records.

The system administrator of block 960 may proceed to block 963 for retailer maintenance. Here, access is provided to lists of registered retailers, registration for new retailers and master invoice messages. At block 963.1, access is provided to various features. From block 963.1 the administrator may proceed to block 965 from which groups of retailers 8 may be provided and new retailers 8 may be registered. The user may proceed to block 965.1 in order to maintain shopping information. Operation may proceed from block 963.1 to block 966 in which particular users for a given retailer are maintained. From block 963, an administrator may also prepare, at block 963.5 a master invoice message.

An administrator may proceed from block 962 to block 967, manufacturer records. Block 967 provides access to a number of functionalities including accounts payable reports, return experience from retailers 8, product specifications for each manufacturer 6 and other fields as the marketing company 3 may wish to maintain. An operator proceeds from block 967 to block 967.1 for processing accounting information, to block 967.2 for performance and product information or to block 967.3 for records maintenance. The administrator may proceed to block 968 to control promotions and contests, which may be periodic or a periodic, e.g. monthly or occasionally. Again, the marketing company 3 may communicate with manufacturers 4 as illustrated in FIG. 1.

What is thus provided in method and system in which a marketing company provides an integrated system to which retailers may subscribe. The marketing company provides a resource to retailer which is branded with the retailer's trade name and trademarks. The user sees a complete system under the retailer's name while not being aware of operation of the marketing company. The marketing company provides information, education, product and fulfillment services. The marketing company goes beyond fulfillment services by integrating manufacturing into the system. Selected manufacturers make selected products and are controlled by the marketing company to provide product to the fulfillment center to meet demands of retailers. The marketing company serves the manufacturing company by providing a stream of order and by drastically reducing the manufacture's working capital requirements. The manufacturers each deal only with the marketing company and do not bear the costs associated with selling to many individual retailers. Many well-know applications may be used in a method and system in accordance with the present invention. Indeed the present invention will also permit the use of many applications that are not yet developed.

The communications described above may be achieved by many different specific signal paths. Many different server arrangements could be provided to provide the functionality of the specific example of server arrangement above. The above teachings will suggest to those skilled in the art many different ways of providing a method and system according to the present invention.

What is claimed is:

1. An integrated method of marketing and supply comprising:
providing a company server storing product information, retailer information and manufacturer information;
providing interactive content with which a shopper may interact to learn about and select product;
providing said content for each of a plurality of jewelers and separately branding said content for each jeweler;
providing an interactive retail center at at least one said retailer for providing the interactive content;
capturing interactions of the shopper with the interactive retail center via a network;
fulfilling orders on behalf of said retailer by a fulfillment center; and
ordering stock from said manufacturers for fulfillment of retailer orders.

2. The method according to claim 1 further comprising providing communication between said fulfillment center and said interactive retail center.

3. The method of claim 2 further comprising providing information interactively between a retailer terminal and the company server.

4. The method according to claim 2 wherein said interactive retail center is provided with actual inventory as well as virtual inventory and wherein said interactive resale terminal provides information in said presentation regarding actual inventory as well as virtual inventory.

5. The method according to claim 2 comprising responding to a shopper's selection of a particular piece of goods and providing in a next display further information about the product and enabling further options for selection by the shopper.

6. The method according to claim 5 comprising providing the user the option to perform a virtual try on routine wherein an image of the product is superimposed on another image.

7. The method according to claim 6 wherein said another image comprises an image of a model.

8. The method according to claim 7 further comprising providing the shopper the option to select one of a plurality of models.

9. The method according to claim 8 wherein the option includes the shopper as a model, and providing video camera means actuatable by the shopper to produce a said another image comprising an image of the shopper.

10. The method according to claim 7 comprising providing the shopper the option to move and resize the image of goods.

11. The method of claim 6 comprising providing the option of selecting a background for said image of goods and said another image.

12. The method according to claim 6 comprising providing the option for a shopper to select translation of the produced image into an e-mail and creating an e-mail in response to the selection and providing said message to the internet.

13. The method according to claim 5 wherein an option to buy is provided and wherein the e-commerce facility is provided and further wherein said shopper's selections are registered at said fulfillment center and at said main server in a storage location associated with said shopper.

14. The method of claim 2 further comprising registering a shopper via said interactive retail center and creating a record at said main server regarding said shopper.

15. The method of claim 14 further comprising storing in said shopper record a record of purchases.

16. The method of claim 15 further comprising providing the option for a shopper to create a wish list, and storing said wish list at the company server.

17. The method of claim 15 further comprising providing an interface at the interactive retail center through which the shopper may communicate graphical information and communicating said graphical information to said main server.

18. The method according to claim 17 further comprising responding to said user regarding the graphical information.

19. The method according to claim 1 further comprising providing said retailer a retailer software package for the retailer to perform retail administration functions and to communicate with the company.

20. The method of claim 19 further comprising providing to the retailer further information content for access through the retailer's software.

21. The method according to claim 1 wherein the fulfillment center performs order payment clearing tasks with regard to the retailer.

22. The method according to claim 21 wherein the fulfillment center may cancel shipment of product to a retailer due to payment history.

23. The system according to claim 1 wherein said fulfillment center generates inventory tracking information and prepares orders for the manufacturers.

24. The method of claim 23 further comprising the step of providing said orders to manufacturers on approval by the company.

25. The method of claim 1 further comprising providing merchandise promotions in interactive content in capturing information from the shopper input in response to participation in the promotion.

26. A system for marketing comprising:
a company server storing product information, retailer information and manufacturer information;
interactive content with which a shopper may interact to learn about and select product
server means providing said content for each of a plurality of jewelers and separately branded for each jeweler;
interactive retail center at at least one said retailer
capturing interactions of the shopper with the interactive retail center via a network;
a fulfillment center fulfilling orders on behalf of said retailer;
a programmed server for generating orders to manufacturers; and
server means communicating to manufacturers each authorized to make products for shipment to the fulfillment center.

27. The system according to claim 26 comprising a communication between said fulfillment center and said interactively linked retail terminal.

28. The system according to claim 27 comprising a programmed server communicating between said fulfillment center and said company server for maintaining inventory control.

29. The system according to claim 28 wherein said interactive retail center includes actual inventory as well as virtual inventory and wherein said interactive content provides information in said presentation regarding actual inventory as well as virtual inventory.

30. The system according to claim 29 comprising means for responding to a shopper's selection of a particular piece of goods and providing in response a next display thereto of further information about the product and providing further options for selection by the shopper.

31. The system according to claim 30 comprising content providing a virtual try on routine wherein an image of the product is superimposed on another image.

32. The system according to claim 31 wherein said another image comprises an image of a model.

33. The system according to claim 32 further wherein said interactive content further comprises providing the shopper the option to select one of a plurality of models.

34. The system according to claim 33 wherein the option includes the shopper as a model, and said interactive retail center comprises a video camera actuatable by the shopper to produce a said another image comprising an image of the shopper.

35. The system according to claim 34 comprising content providing the shopper the option to move and resize the image of goods.

36. The system of claim 35 comprising content providing the option of selecting a background for said image of goods and said another image.

37. The system according to claim 36 comprising content providing the option for a shopper to select translation of the produced image into an e-mail and creating an e-mail in response to the selection and providing said message to the internet.

38. The system according to claim 37 wherein said content provides an option to buy through an e-commerce facility and further wherein said shopper's selections are registered at said fulfillment center and at said main server in a storage location associated with said shopper.

39. The system of claim 26 further comprising means for storing registering of a shopper at said interactive retail center and creating a record at said main server regarding said shopper.

40. The system of claim 39 further comprising means storing in said shopper record a record of purchases.

41. The system of claim 40 further comprising means storing a wish list for a shopper entered at said interactive retail center.

42. The system of claim 39 further comprising an interface at the interactive retail center through which the shopper may communicate graphical information and communicating said graphical information to said company server.

43. The system according to claim 42 further comprising means in said company storing servers said users graphical information.

44. The system according to claim 26 further comprising a retailer software package resident in a retailer server for the retailer to perform retail administration functions and to communicate with the company.

45. The system of claim 44 further comprising a communications link to the company server through the retailer software.

46. The system according to claim 26 wherein the fulfillment center contains a program for performing order payment clearing tasks with regard to the retailer.

47. The system according to claim 46 wherein the fulfillment center comprises means storing retailer payment history.

48. The system according to claim 26 wherein said fulfillment center comprises inventory tracking information and prepares order preparation software.

49. The system of claim 48 further comprising means for communicating orders to manufacturers.

50. The system of claim 26 further additional content providing merchandise promotions and means for capturing information from the shopper input in response to participation in the promotion.
